(19) United States
(12) Patent Application Publication
(10) Pub. No.: US 2012/0061181 A1
(43) Pub. Date: Mar. 15, 2012

(54) EASY STEP EXAMINATION TABLE DEVICE

(76) Inventor: FUNMI ONOBRAKPEYA, York, PA (US)

(21) Appl. No.: 13/089,670

(22) Filed: Apr. 19, 2011

Related U.S. Application Data
(60) Provisional application No. 61/382,961, filed on Sep. 15, 2010.

(51) Int. Cl. E06C 1/26

(52) U.S. Cl. 182/159; 182/156

(57) ABSTRACT

An exemplary embodiment is an assistive device for enabling individuals with limited mobility to step up to a generally horizontal patient support apparatus having: a pair of foldable frames each having a generally U-shaped vertical side frame. Each of the frames has a plurality of horizontal support members and is coupled to one or more horizontal support bars that are located at a rear of the device. A plurality of foldable steps is coupled to the frames. A method of a patient/user using the device described above includes the acts of: unfolding a folded device (if folded); placing the device with a rear portion facing and against an examination table or bed. Having the patient/user grip a pair of grips and placing a first foot on a lower step. The patient then places a second foot on an upper step with the first foot remaining on the lower step while maintaining his/her hands on the grips. The patient then places the second foot on the second step, thus having both feet on the upper step and in a standing position while gripping the grips. The patient then turns around on the upper step to face away from the examination table or bed while still gripping the grips and moving to a sitting position on the examination table.

### CROSS REFERENCE

This application is related to provisional application Ser. No. 61/382,961 filed on Sep. 15, 2010 entitled “Easy Step Examination Table Device” and is hereby incorporated herein by reference.

### FIELD OF TECHNOLOGY

The field of technology is an assistive device to enable individuals with limited mobility to step up to an examination table in a physician's office during physical examinations.

### BACKGROUND

There is a need for an assistive device that enables an individual with limited mobility to step up to an examination table in a physician's office during a physical examination. As a physician, the Applicant has observed the difficulties that elderly and patients with limited mobility experience during attempts to transfer them to a medical examination table during visits. The Applicant has observed the need for a product that facilitates the transfer of these patients by the physicians or medical staff more conveniently and expediently to the table for medical examination.

Such a device needs to be a stepping device with handles for support and short, wide steps which allow patients to climb up to the examination table with ease and turn around to sit on the table without an increased risk of falling. The design of older examination tables currently in use does not address this problem and the newer examination tables being manufactured are very expensive costing 5-10 times the price of the older tables now in use. Therefore there is a need for a cost effective solution to the current problem that is expected to increase in magnitude over time since the population is aging.

The primary need for such a device is in a physician's office with a large geriatric patient population such as internists, geriatricians, rheumatologists and orthopedic surgeons who see a large population of the infirm and younger patients with difficult mobility. Ultimately all physicians and medical practitioners will need such a device since there are aging patients in most of the medical specialties. The secondary need for such a device is in the general population of the elderly, and those with limited mobility who will benefit day to day use of the product at home. These needs would be met by a standalone device that satisfies the needs of the patients and the physicians. A tertiary need for the device is one that it is incorporated within an examination table made by manufacturers of examination tables, where there exists a need for such a device in the design of future medical examination tables.

In addition, such a device would satisfy the need for: Increased patient satisfaction and improvement in overall patient experience; Increased efficiency of office staff, with less time spent transferring patients to examination tables therefore improving office work flow; and Decreased time spent by physicians in patient transfers on and off the examination table allowing more time to be spent during the visit in discussions with the patient.

The most commonly used examination table known to the Applicant that provides a step function to an examination table surface is described in U.S. Pat. No. 6,550,084 ('084) by Siepman et al and assigned to The Brewer Company entitled “Medical Examination Table Step” and is sold by Brewer as its Brewer Basic Exam Table. FIG. 1 illustrates the '084 table with the table step inside the table structure. FIG. 2 illustrates the '084 table with the table step outside the table structure. FIG. 3 illustrates the details of the structure of the '084 table step. FIG. 4 illustrates details of the rolling process of the '084 table step.

Another commonly used examination table with a drawer type step is described in U.S. Pat. No. 7,386,899 ('899) by Smith and assigned to the Midmark Corporation. The '899 device is sold by Midmark as its Midmark 604 and Ritter 204 examination tables. FIG. 5 illustrates the '899 table with the table step in the open position. FIG. 6 illustrates details of the '899 table step.

Many conventional medical examination tables have a step that is movable from a stored position to a position for use by the patient as an aid to mount the examination table. Typically, such steps incorporate a hinge mechanism, whereby the step rotates from a stored position to a position for mounting, or a cantilevered track configuration whereby the step extends into a useful position in a drawer-like manner.

Retractable steps are desirable on medical examination tables because they provide an aid to the patient when mounting the examination table. Further, the step can be stored in the table when not in use, thus permitting better access to the patient, and removing obstacles from what are typically cramped examination rooms.

By means of example, Kales (U.S. Pat. No. 487,625) ('625) describes a cantilevered sliding step with hinged support braces and a pull-out handle. In another example, Daggett (U.S. Pat. No. 488,649) ('649) describes a retractable cantilevered step. Lentz's U.S. Pat. No. 542,060 ('060) describes a hinged step coupled to a leg rest of the examination table. When the leg rest is in a vertical position, the step can be placed in a horizontal position, enabling the patient to mount the examination table. When the leg rests are placed in a horizontal position, the step can be rotated to lie in line with the leg rest by means of the hinge mechanism.

In another example, Grant's U.S. Pat. No. 3,016,275 describes a cantilevered pull-out step that is guided by tracks. The step is retracted by pulling on a lower edge of a front side of the step. A step is again described by Douglass' U.S. Pat. No. 3,334,951 ('951). Douglass uses a cantilevered step that is slideably mounted on guide tracks by means of a guide rail. An upper face of the step has a tread to ensure adequate traction. Kharchik's U.S. Pat. No. 6,209,463 ('463) describes a cantilevered retractable footstool including a runner with a locking mechanism that selectively limits the extension of the step in relation to the table.

One disadvantage common to the much of the prior art is the use of a cantilevered step. The use of such a design may compromise patient safety. An overly large step tends to act as a lever and the typical patient would then topple the examination table when using the step. To avoid this, some of the prior art uses a rather narrow cantilevered step. This creates another disadvantage, as the step then is too small for patients to safely mount the examination table. While preventing the table from toppling, such small steps may cause the patient to fall!

In an attempt to alleviate such misfortune, the aforementioned Kales ('625) device incorporates support legs that hinge from the cantilevered step. However, the mechanism that automatically deploys the hinged braces is cumbersome and unreliable. Consisting of narrow members and a strap guided by a groove, the Kales mechanism is relatively delicate, susceptible to jamming or breaking and the braces may be inadvertently dislodged by the patient or care provider during use, resulting in a dangerous situation.

Another disadvantage of much of the prior art is the use of guide tracks and guide rails to retract and extend the step by sliding. This arrangement is susceptible to jamming and sticking, as a relatively large frictional surface on the guide rail and guide track are continually in contact. Such designs are largely not self-aligning, which further exacerbates the problem of jamming and sticking. Another disadvantage of much of the prior art is a lack of means for preventing over extension or excessive retraction of the step. A major disadvantage of much of the prior art is that the steps have a small elevated supporting surface, making it difficult for patients to maneuver and turn on the step while trying to mount the table.

Accordingly, the retractable step of the Siepman/Brewer ('084) device that is self-supporting, thereby eliminating the dangerous toppling condition is a step forward. The Siepman/Brewer '084 device has a relatively large step in order to improve the ease of use and patient maneuverability when used. The retractable step of the Siepman/Brewer '084 slides easily from the stored position to the extended position and returns as easily, without sticking or jamming avoids over extension or excess retraction by a self-assuring means.

However, Siepman-Brewer '084 device does not satisfy the need for an appropriate stepping device that meets the needs of individuals who are elderly or have limited mobility and safely provides support, in the applicant's experience with such individuals.

### SUMMARY

There are two principal embodiments of the invention described that satisfy the needs cited in the Background of the invention. The first embodiment is a portable device that is used in conjunction with an existing medical examination table. Another embodiment is a device attached to a Siepman-Brewer ('084) device, a Smith-Midmark ('899) device, or a similar examination table with a pull out step system.

The stand-alone device is similar to a walker or rollator in appearance, but serves a uniquely different function. A rollator or walker assists a patient with walking therapy or assists the patient overcome stability and or energy functions while walking. The first embodiment enables an individual with limited mobility to step up to and easily get access to an examination table in a physician's office during a physical examination or a hospital bed in a hospital or home.

A first embodiment relates generally to an ambulatory support having one or more rigid steps to allow the user to step up safely and easily to an examination table or other horizontal or mostly horizontal support devices. Further, the side frame members of the device can be folded inwardly in order to conserve storage space.

This first embodiment is more fully described as an assistive device for enabling individuals with limited mobility to step up to a generally horizontal patient support apparatus having: a pair of foldable frames each having a generally U-shaped vertical side frame. Each the frames has a plurality of horizontal support members; the frames are coupled to one or more horizontal support bars that are located at a rear of the device; and a plurality of foldable steps coupled to the frames.

A method of using the device is described as: A method of a patient/user using the device described above including the acts of: unfolding a folded device (if folded); placing the device with a rear portion facing and against an examination table or bed; gripping a pair of grips and placing a first foot on a lower step; placing a second foot on an upper step with the first foot remaining on the lower step maintaining his/her hands on the grips; placing the second foot on the second step, thus having both feet on the upper step and in a standing position while gripping the grips; turning around on the upper step to face away from the examination table or bed while still gripping the grips; and moving to a sitting position on the examination table.

### BRIEF DESCRIPTION OF THE DRAWINGS

These and other features, aspects, and advantages of the present embodiment(s) of the invention will become better understood with regard to the following description, appended claims, and accompanying drawings where:

FIG. 1 illustrates the '084 table with the table step inside the table structure;

FIG. 2 illustrates the '084 table with the table step outside the table structure;

FIG. 3 illustrates the details of the structure of the '084 table step;

FIG. 4 illustrates details of the rolling process of the '084 table step;

FIG. 5 illustrates the '899 table with the table step in the open position;

FIG. 6 illustrates details of the '899 table step:

FIG. 7 illustrates a left side elevation of a basic embodiment of the assistive device in an open position in accordance with the present invention;

FIG. 8 illustrates a right side elevation of a basic embodiment of the assistive device in an open position in accordance with the present invention;

FIG. 9 illustrates a front view of the assistive device shown in FIG. 7 in an open position;

FIG. 10 illustrates an isometric front view of the assistive device;

FIG. 11 illustrates an isometric rear view of the assistive device;

FIG. 12 illustrates a closed position of the assistive device with the steps in a folded position and the sides folded inward;

FIG. 13 illustrates a user facing the device that has been placed in front of an examination table;

FIG. 14 illustrates the patient/user with his/her hands gripping the handles and with a first foot on a lower step of the device.

FIG. 15 illustrates the patient/user with his/her second foot on the upper step of the device and the first foot remaining on the lower step of the device while maintaining his/her hands on the grips on the device;

FIG. 16 illustrates the patient/user with both feet on the upper step and is in a standing position on the device while gripping the grips;

FIG. 17 illustrates the patient/user having turned around on the upper step to face away from the examination table while still gripping the grips on the device; and

FIG. 18 illustrates the patient/user in a sitting position on the examination table.

### DETAILED DESCRIPTION

There are two principal embodiments of the invention are described that satisfy the needs cited in the Background section. A first embodiment is a portable device that is used in conjunction with an existing medical examination table. The second embodiment is a device attached to a Siepman-Brewer ('084) device, a Smith-Midmark ('899) device, or a similar examination table with a pull out step system.

The stand-alone device is similar to a walker or rollator in appearance, but serves a uniquely different function. A rollator or walker assists a patient with walking therapy or assists the patient overcome stability and or energy functions while walking. The first embodiment enables an individual with limited mobility to step up to and easily get access to an examination table in a physician's office during a physical examination; in a hospital bed in a hospital or home; or another horizontal support device.

The first embodiment relates generally to an ambulatory support having one or more rigid steps to allow the user to step up to an examination table or other horizontal or mostly horizontal support devices. Further, the side frame members of the device can be folded inwardly in order to conserve storage space. The second embodiment is the combination of an assistive device and the ability to store the assistive device into the examination table when the assistive device is not needed.

### First Embodiment

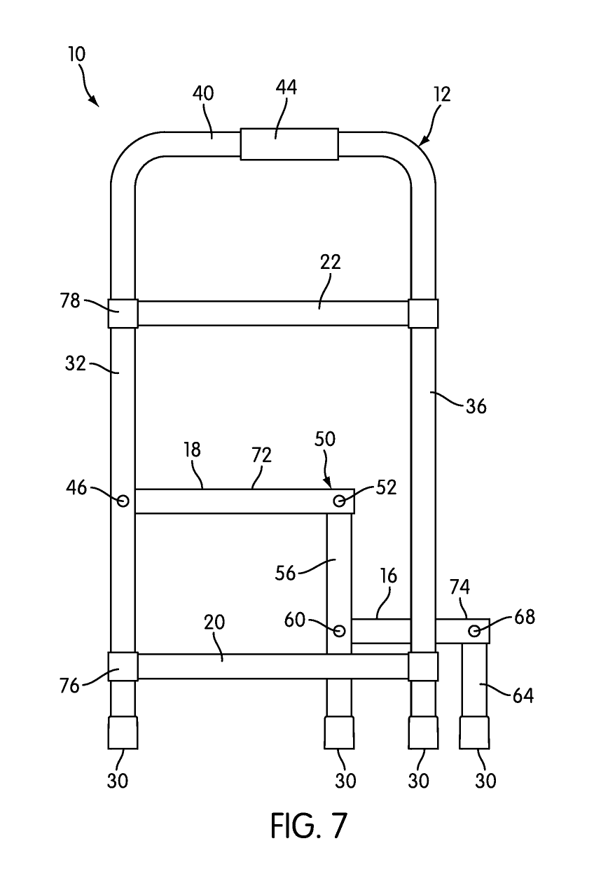

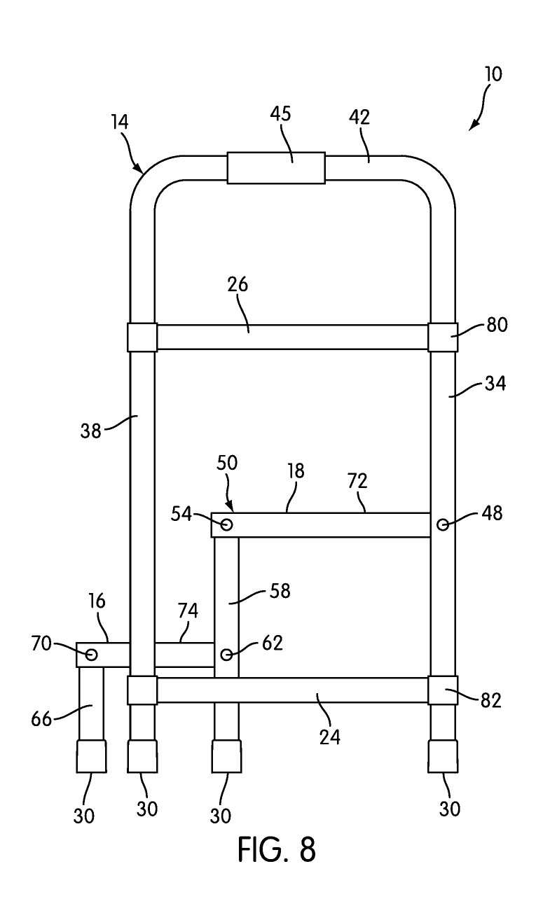

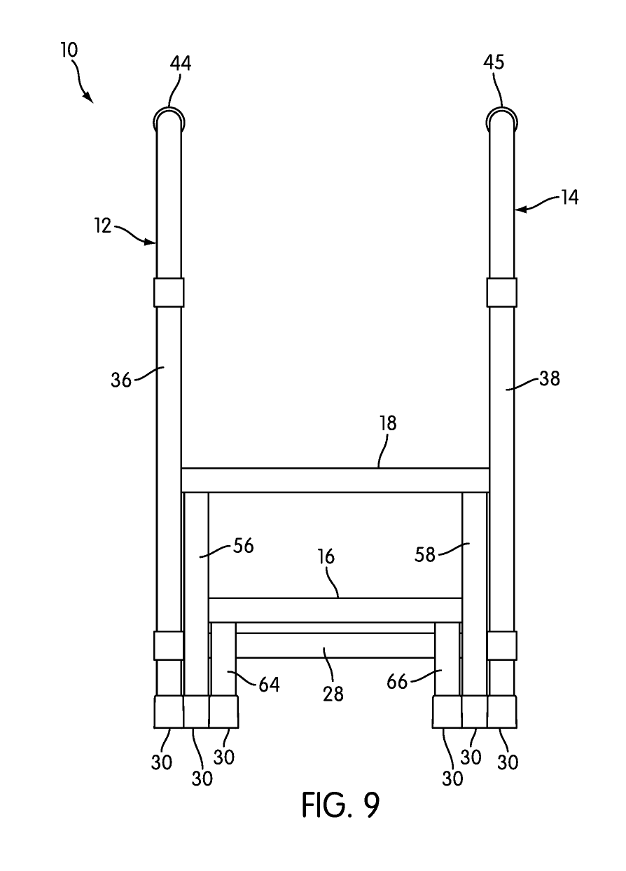

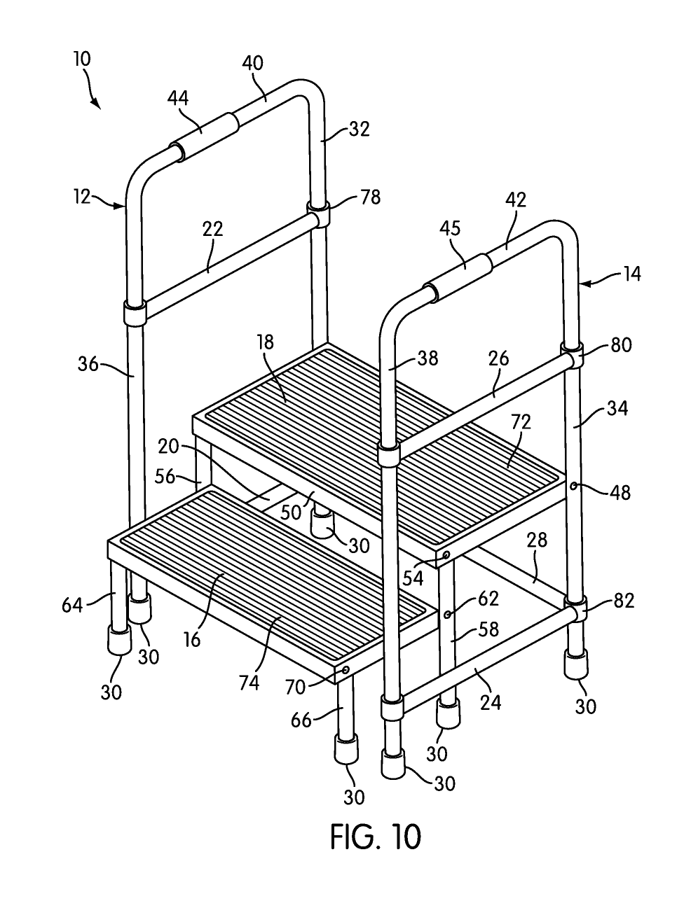

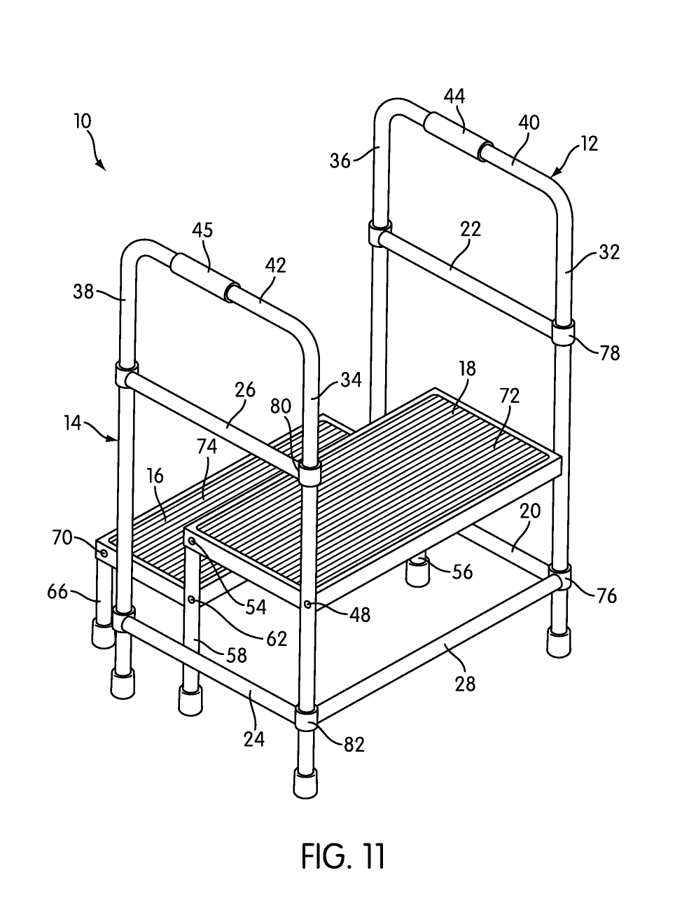

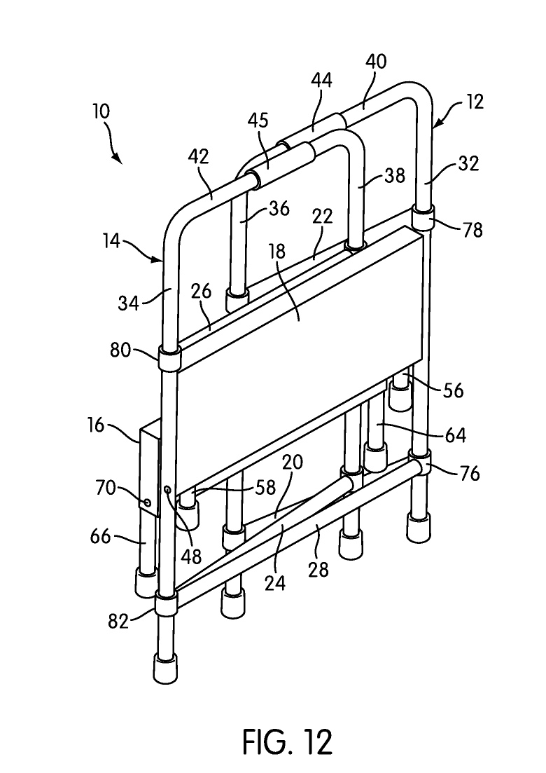

The first embodiment of the assistive device is a stepping device 10 illustrated in a first (left) side view in FIG. 7, a second (right) side view in FIG. 8 and a rear view in FIG. 9. FIG. 10 illustrates an isometric front view of the assistive device and FIG. 11 illustrates an isometric rear view of the assistive device. FIG. 12 illustrates a closed position of the assistive device with the steps in a folded position and the sides folded inward.

The assistive device called Easy Step is comprised of opposing side frames 12 (left side) and 14 (right side) linked to one or more steps 16 and 18; and a plurality of support bars 20, 22, 24, 26, and 28 and.

The assistive device of the present embodiment has a pair of foldable frames having generally U-shaped vertical side frames 12 (left side), 14 (right side) which are typically of a hollow tubular steel, aluminum or composite material construction. The side frames 12 (left side), 14 (right side) each include a front leg 32 (left side) and 34 (right side) and a back leg 36 (left side), 38 (right side). These front and back legs and the legs of the steps are each supported at the bottom by a friction device such as a rubber, plastic, cloth or felt cup 35. At the top of these vertical frames 12 (left side) and 14 (right side) each has an integral transverse horizontal support member 40 (left side) and 42 (right side) and are positioned to carry a hand grip 44 (left side) and 45 (right side) which the user may use to assist him or her in using the device. At approximately 2/3 of the height of these vertical frames 12 (left side) and 14 (right side) they have a second transverse horizontal support member 22 (left side) and 26 (right side). An additional integral transverse horizontal support member 20 (left side) and 24 (right side) is positioned near the bottom of each vertical side frame. There is an option to add a second horizontal support member higher in the device to provide further structural support. The rear of an upper step of a pair of foldable steps 18 (lower step) and 16 (upper step) is coupled at its rear portion to the front legs 32 (left side) and 34 right side) by a first pair of folding mechanisms 46 (left side) and 48 (right side). The front of an upper step 50 is coupled to the second pair of folding and locking mechanisms 52 (left side) and 54 (right side) provides a location for the foldable steps 16 and 18 to reside in their folded position. The front of the upper step 18 is coupled to the pair of upper step front legs 56 (left side) and 58 (right side) via the second pair of folding and locking mechanisms 52 (left side) 54 (right side) that lock in the 90 degree position as illustrated in FIGS. 7 and 8.

The rear of a lower step 16 is coupled to the upper step front legs 56 (left side) and 58 (right side) via a third pair of folding 60 (left side) 62 (right side). This mechanism provides support for the rear of the lower step as well as support for the front of the upper step. The front of the lower step 16 is coupled to the lower step front legs 64 and 66 via a fourth pair of folding mechanisms 68 (left side) and 70 (right side). The upper and lower steps have a friction surface 72 (upper step) and 74 (lower step) to provide stability for the user. This may be made of rubber or a form of rubberized plastic. FIG. 9 illustrates Easy Step assistive device with its steps 16 and 18 folded upward and the side frames 12 and 14 folded inward. This folded configuration makes carrying and storing the device easier. The front legs of each side frame 12 and 14 are hinged to the support bars at 74, 76, 78 and 80 for folding side frames 12 and 14 inwardly.

In a preferred embodiment, the total height of the Easy Step assistive device is approximately 42 inches in height, 22 inches wide and 20 inches deep. The lower step 42 is approximately 5 inches from the floor with the upper step 44 being approximately 10 inches from the floor. The lower step is approximately 18 inches wide and 10 inches deep. The upper step is approximately 20 inches wide and 15 deep. The depth of the upper step is designed to give the patient user space to turn around after stepping up to the upper step before placing himself or herself on the examination table. The horizontal support mechanisms containing the grips are approximately 38 inches from the ground, and 6 inches above the examination table or other horizontal support device. The total weight of the device is approximately 10 pounds and will support a patient/user weighing up to 400 pounds. An optional feature is to make the height of the device adjustable by making the length of the legs 32, 34, 36 and 38 adjustable.

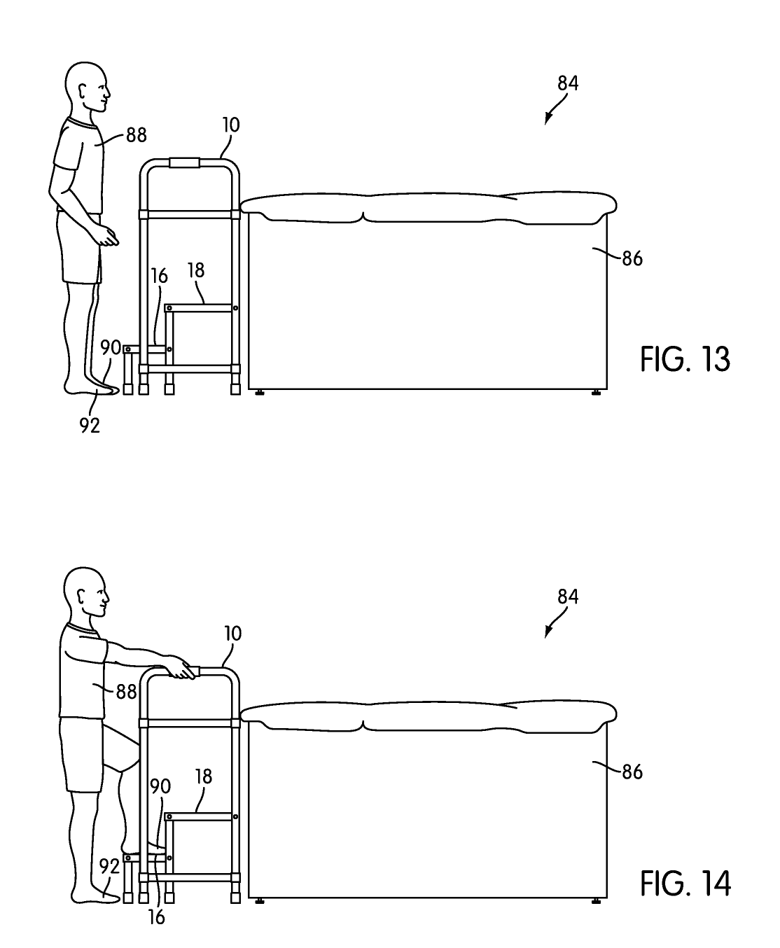

FIGS. 13-18 illustrate a patient's/user's progression 100 from a beginning position in front of the device 10 (in its open position) to the patient's/user/s sitting position on the examination table 102. FIG. 13 illustrates the user facing the device 10 that has been placed in front of a position on the examination table or bed 104 with its rear portion against the examination table or bed. The location of the device 10 with regard to the examination table 104 is up to the discretion of the physician or other care taker.

FIG. 14 illustrates a second portion of the progression of the patient/user with his/her hands gripping the handles 106 and with a first foot 108 on the lower step 110 of the device 10. As illustrated, the first foot is a left foot, but may be the right foot 112.

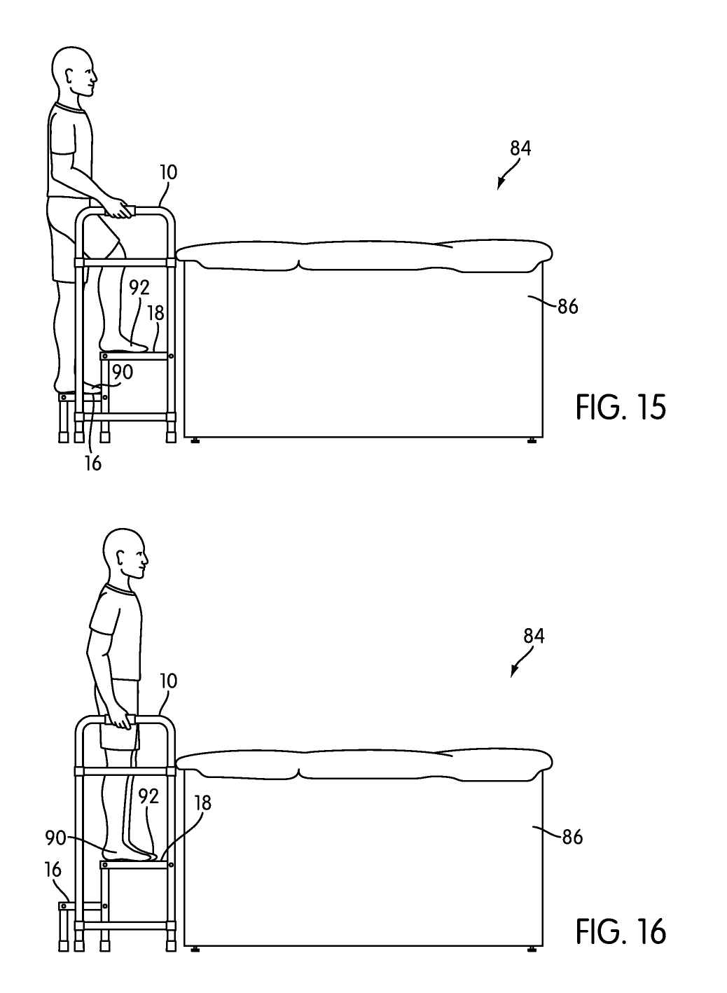

FIG. 15 illustrates the next portion of the progression of the patient/user 102 with his/her second foot 112 on the upper step 114 of the device 10 and the first foot 108 remaining on the lower step 110 of the device 10 while maintaining his/her hands on the grips 106 on the device 10. As illustrated, the first foot is a left foot and the second foot is a right foot, but it may be the reverse.

FIG. 16 illustrates the next portion of the progression of the patient/user 102 with both feet 108 and 112 on the upper step 114 and is in a standing position on the device 10 while gripping the grips 106.

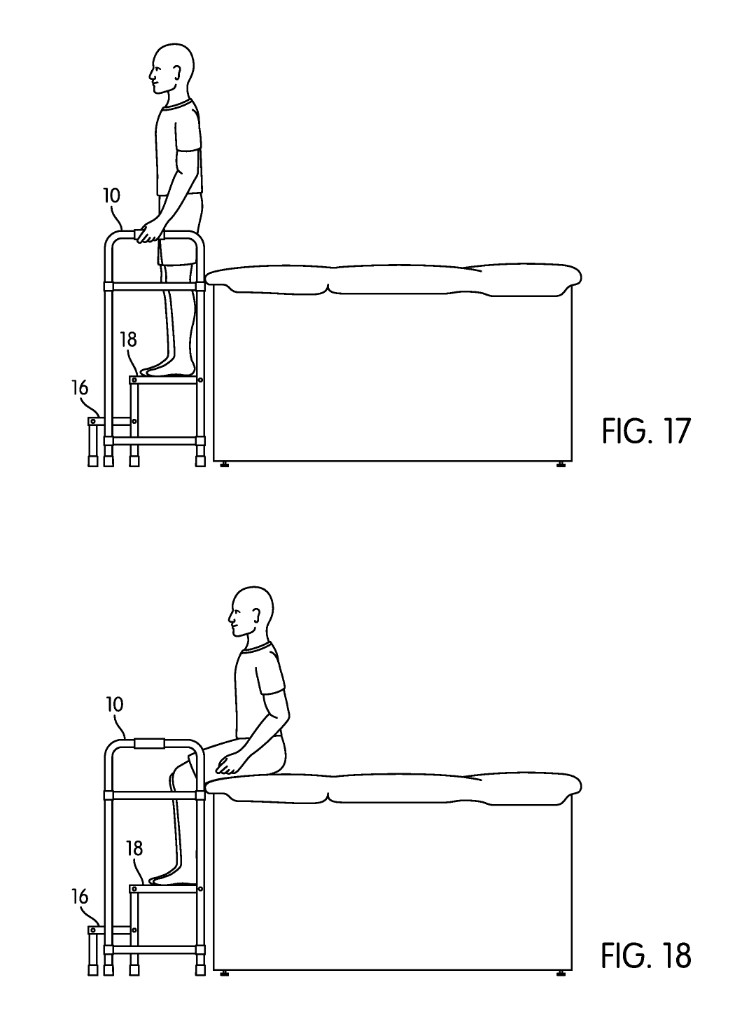

FIG. 17 illustrates the next of the progression of the patient/user 102 with the patient/user 102 having turned around on the upper step 114 to face away from the examination table while still gripping the grips 106 on the device 10.

FIG. 18 illustrates the conclusion of the patient/user progression from a beginning position in front of the device 10 (in its open position) to the patient's/user/s sitting position on the examination table 102.

Upon conclusion of his/her examination, the patient/user reverses the progression to step down the device. In this case however, the patient may or may not turn around on the upper step as he/she may be more comfortable going down the step with his/her body facing away from the device 10 and examination table 104.

Prior to the progression described above, a caretaker or patient/user may unfold a folded device 10 and place the unfolded device in front of the examination table as illustrated in FIGS. 13-18. After use of the device 10 is completed a caretaker or patient/user may fold the device 10 as illustrated in FIG. 12.

### Second Embodiment

A second embodiment may include the addition of a wheel and brake system on the device so that it may be moved from one location to another without having to carry the device. More complicated embodiments are possible including those with wheels and/or an adjustable height for the user. If wheels are sued, it may be necessary to have brakes to prevent the device from moving while in use. The wheel and brake system described in U.S. Pat. No. 7,040,637 ('637) describing a rollator is an example of such a wheel and brake system. The '637 patent is incorporated herein by reference.

A third embodiment of the invention is an assistive device discussed in the first embodiments attached to or stored within a Siepman-Brewer ('084) device, a Smith-Midmark ('899) device, or a similar examination table with a pull out step system.

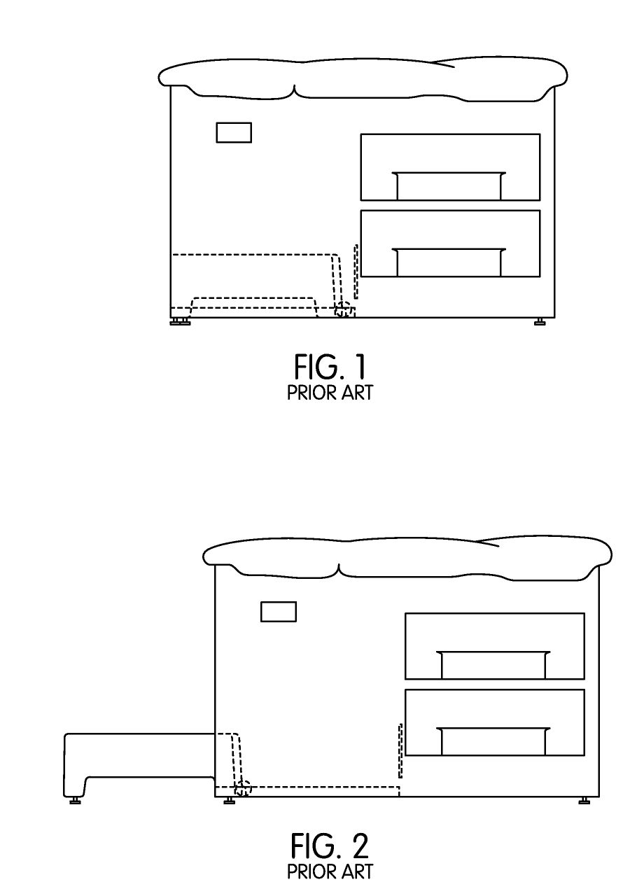

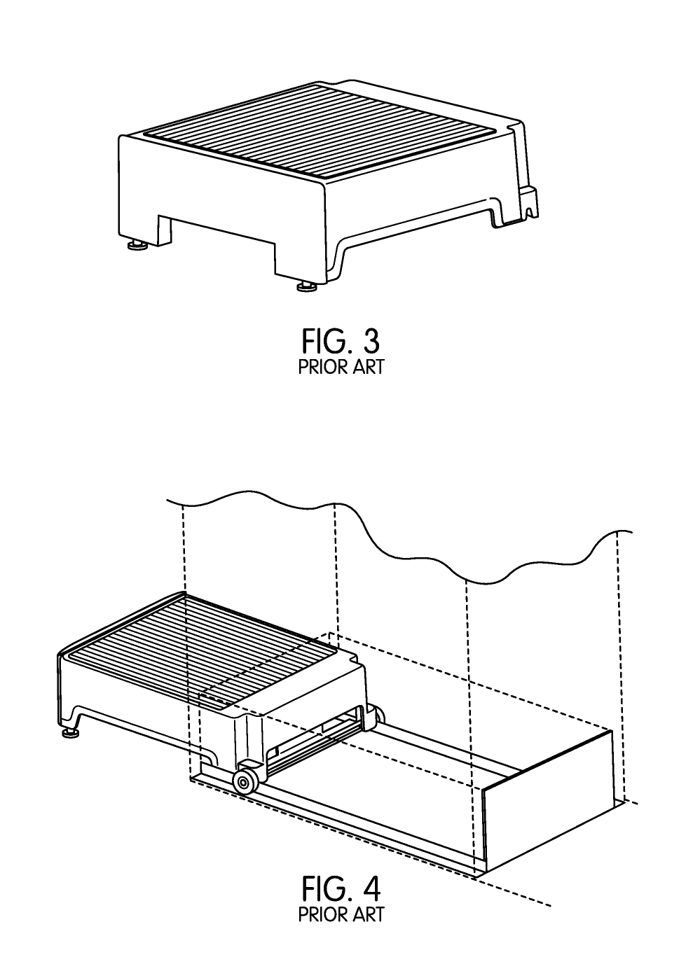

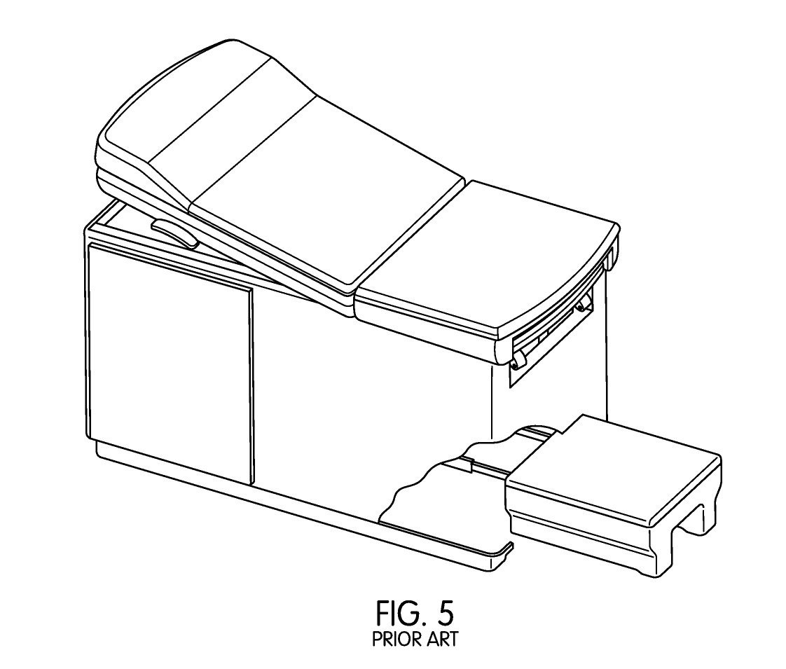

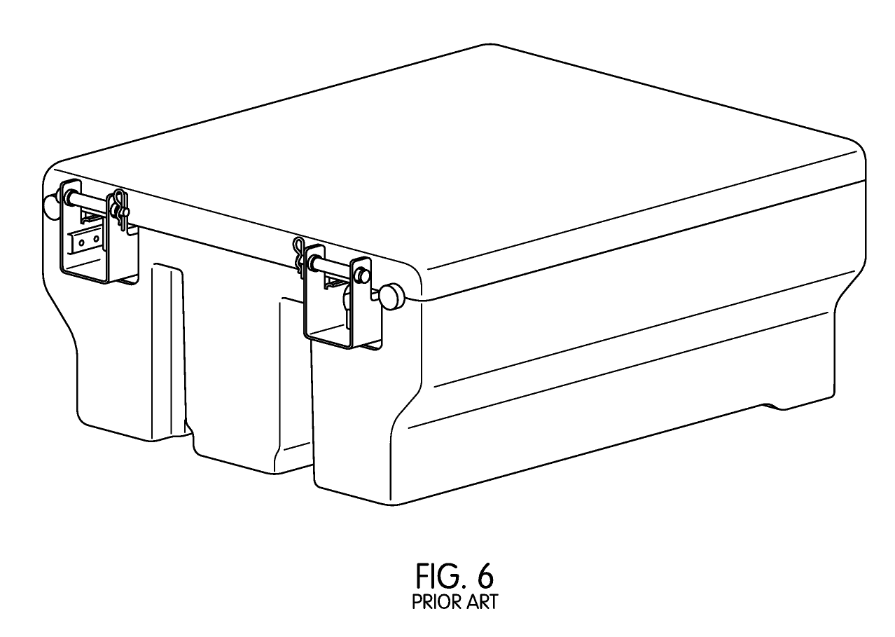

As was shown in FIGS. 1-6, the Siepman-Brewer ('084) and Smith-Midmark ('899) devices are medical examination tables with pull out drawers. The third embodiment of the invention is the attachment or storage of an assistive device as described in the first embodiment. This would be a non-wheel version as wheels are not needed when attached to the examination table. The storage may comprise folding the device as described above and rolling (if it has wheels) or carrying the folded device into the space previously used by the pull out step drawers in the Siepman-Brewer ('084) and Smith-Midmark ('899) medical examination tables with pull out drawers.

All the features disclosed in this specification (including any accompanying claims, abstract, and drawings) may be replaced by alternative features serving the same, equivalent or similar purpose, unless expressly stated otherwise. Thus, unless stated otherwise, each feature disclosed is one example only of generic series of equivalent or similar features. Additionally, all the US Patents referenced above are hereby incorporated herein by reference.

We claim:

1. An assistive device for enabling individuals with limited mobility to step up to a generally horizontal patient support apparatus comprising:
a pair of foldable frames each having a generally U-shaped vertical side frame;
each said frames has a plurality of horizontal support members;
said frames are coupled to one or more horizontal support bars that are located at a rear of said device; and
a plurality of foldable steps coupled to said frames.

2. The device of claim 1 further comprising:
each said frame includes a front leg and a back leg.

3. The device of claim 2 further comprising:
each said frame includes a first horizontal support member at its top and is positioned to carry a hand grip.

4. The device of claim 3 further comprising:
each said frame's front leg and back leg are coupled to a second horizontal support member at approximately 2/3 of said frame height.

5. The device of claim 4 further comprising:
each said frame's front and back legs are coupled to a third horizontal support member at a lower location.

6. The device of claim 5 further comprising:
each back leg of said frames is coupled to one or more horizontal support bars.

7. The device of claim 6 further comprising;
coupling of said frames to one or more horizontal support bars using folding mechanisms that lock into a 90 degree position.

8. The device of claim 6 further comprising:
a plurality of foldable steps that are hingedly coupled to said back legs of said frames.

9. The device of claim 7 further comprising:
an upper step of a pair of foldable steps is hingedly coupled to said front legs by a first pair of folding mechanisms.

10. The device of claim 9 further comprising:
said first pair of folding mechanisms provides a location for said foldable steps to reside into a folded position.

11. The device of claim 10 further comprises:
a front of said upper step is coupled to a pair of upper step front legs by a second pair of folding that hold said legs in a 90 degree position.

12. The device of claim 11 further comprising:
a back of said lower step is coupled to said pair of upper step front legs by a third pair of folding mechanisms that hold said legs in a 90 degree position.

13. The device of claim 12 further comprising:
a front of said lower step is coupled to a pair of lower step front legs by a fourth pair of folding mechanisms that hold said in a 90 degree position.

14. The device of claim 13 wherein said folding steps are folded upward and the side frames are folded inward for storage of said device.

15. The device of claim 14 wherein said device support elements are made of aluminum, steel or composite materials.

16. The device of claim 15 wherein said each of said steps has a non-slip surface on a stepping surface to provide a safe support for a patient/user.

17. The device of claim 16 wherein said non-slip surface is composed of rubber or rubberized plastic.

18. The device of claim 17 wherein each said leg has a friction cup.

19. The device of claim 18 wherein said friction cup is made of rubber, rubberized plastic, cloth or felt,

20. The device of claim 15;
wherein said device is approximately 42 inches in height, 22 inches wide and 20 inches deep with said lower step being approximately 5 inches from the floor with the upper step being approximately 10 inches from the floor;
further within said lower step is approximately 18 inches wide and 10 inches deep and said upper step is approximately 20 inches wide and 15 inches deep; and
further wherein said grips are approximately 38 inches from the ground and 6 inches above generally horizontal patient support device.

21. The device of claim 1 wherein said device is designed to support a patient/user of approximately 400 pounds.

22. An assistive device for enabling individuals with limited mobility to step up to a generally horizontal patient support device comprising:
a pair of foldable frames each having a generally U-shaped vertical side frame;
each said frame each has a front leg and a back leg;
each said frames has a first horizontal support member at its top and is positioned to carry a hand grip;
each said frame at approximately 2/3 of its height has a second horizontal support member;
each said frame has a third horizontal support member at a lower location;
said frames are coupled to one or more horizontal support bars that are located at a rear of said device;
said coupling of said frames to said one or more horizontal support bars uses frame folding mechanisms that lock into a 90 degree position;
said assistive device further comprises a pair of foldable steps that are hingedly coupled to said back legs of said frames;
an upper step of said pair of foldable steps is hingedly coupled to said front legs by a first pair of folding mechanisms;
a rear of said upper step is coupled to said first pair of folding mechanisms and provides a location for said foldable steps to reside in their folded position;
a front of said upper step is coupled to a pair of upper step front legs by a second pair of folding mechanisms that holds said legs in a 90 degree position;
a rear of said lower step is coupled to said pair of upper step front legs by a third pair of folding mechanisms that lock holds said legs in a 90 degree position;
a front of said lower step is coupled to a pair of first step front legs by a fourth pair of folding and locking mechanisms that holds said legs in a 90 degree position;
wherein said device is approximately 42 inches in height, 22 inches wide and 20 inches deep with said lower step being approximately 5 inches from the floor with the upper step being approximately 10 inches from the floor;
further within said lower step is approximately 18 inches wide and 10 inches deep and said upper step is approximately 20 inches wide and 15 inches deep; and
further wherein said grips are approximately 38 inches from the ground and 6 inches above generally horizontal patient support device.

23. The device of claim 22 wherein said device is designed to support a patient/user of approximately 400 pounds.

24. The device of claim 22 wherein said folding steps are folded upward and the side frames are folded inward for storage of said device.

25. A method of a patient/user using the device described in claim 1 comprising the acts of:
unfolding a folded device (if folded);
placing said device with a rear portion facing and against an examination table or bed;
gripping a pair of grips and placing a first foot on a lower step;
placing a second foot on an upper step with said first foot remaining on said lower step maintaining his/her hands on said grips;
placing said second foot on said second step, thus having both feet on said upper step and in a standing position while gripping said grips;
turning around on said upper step to face away from said examination table or bed while still gripping the grips; and
moving to a sitting position on said examination table.

26. The method of claim 25 wherein said first foot is a left foot and said second foot is a right foot.

27. The method of claim 25 wherein said first foot is a right foot and said second foot is a left foot.

28. The method of claim 25 wherein said patient user reverses the process of claim 25 to step down from the generally horizontal patient device, however, said patient may choose to not turn around on said upper step, thus remaining facing away from generally horizontal patient support device through the whole process.
